(19) United States
(12) Patent Application Publication
(10) Pub. No.: US 2025/0271331 A1
(43) Pub. Date: Aug. 28, 2025

(54) OPTICAL INSPECTION SYSTEM EMBEDDED IN AN INLET PROBE BODY

(71) Applicant: RTX CORPORATION, Farmington, CT (US)

(72) Inventors: Eli Warren, Wethersfield, CT (US); Bryan Hackett, Berlin, CT (US)

(21) Appl. No.: 18/585,249

(22) Filed: Feb. 23, 2024

(51) Int. Cl. G01M 15/05; G01M 15/02; G01M 15/04

(52) U.S. Cl. CPC G01M 15/05; G01M 15/02; G01M 15/046

(57) ABSTRACT

A turbine engine includes an inlet guide vane assembly that includes a plurality of inlet guide vanes that are disposed forward of the fan. An optical inspection system includes a probe body that extends into the inlet air flow path upstream of the inlet guide vane assembly. The optical inspection system includes an optical device that is at least partially disposed within the probe body with a field of view directed between at least two of the inlet guide vanes of the plurality of fan blades.

### BACKGROUND

A gas turbine engine typically includes a fan section, a compressor section, a combustor section, and a turbine section. The fan section includes a plurality of rotating blades that may be susceptible to damage from foreign objects. Accordingly, the blades are periodically inspected to verify continued structural integrity. However, visual inspection of blades is costly, time intensive, and requires specially trained technicians.

Turbine engine manufacturers continue to seek improvements to engine performance, operation, and maintenance.

### SUMMARY

A turbine engine according to an exemplary embodiment of this disclosure includes, among other possible things, a fan that includes a plurality of fan blades that are rotatable about an axis, an inlet guide vane assembly that includes a plurality of inlet guide vanes that are disposed forward of the fan, a case structure that circumscribes the plurality of fan blades and the inlet guide vane assembly. The case structure defines a portion of an inlet air flow path, and an optical inspection system includes a probe body that extends from the case structure into the inlet air flow path upstream of the inlet guide vane assembly. The optical inspection system includes an optical device that is at least partially disposed within the probe body with a field of view directed between at least two of the inlet guide vanes of the plurality of fan blades.

In a further embodiment of the foregoing turbine engine, the optical device includes a lens that is disposed within a trailing edge of the probe body and an optical path from the lens to a camera.

In a further embodiment of any of the foregoing turbine engines, the camera is disposed at a location remote from the lens.

In a further embodiment of any of the foregoing turbine engines, the optical path includes an optical fiber between the lens and the camera.

In a further embodiment of any of the foregoing, the turbine engine further includes a lighting device that is disposed within the probe body and configured to illuminate the field of view.

In a further embodiment of any of the foregoing, the turbine engine further includes a purge flow path for directing a purge flow across the lens.

In a further embodiment of any of the foregoing turbine engines, the inlet guide vanes are at least partially variable to adjust a direction of inlet airflow toward the plurality of fan blades.

In a further embodiment of any of the foregoing turbine engines, the optical inspection system includes at least two optical devices that are focused on a different radial region of the plurality of fan blades.

In a further embodiment of any of the foregoing, the turbine engine further includes a temperature probe that is disposed in the probe body.

In a further embodiment of any of the foregoing turbine engines, the optical inspection system further includes a controller that is programmed to receive images of a portion of at least one of the plurality of fan blades in response to a rotational speed of the fan being with a predefined speed.

In a further embodiment of any of the foregoing turbine engines, the controller is further programmed to determine a condition of at least one of the plurality of fan blades based on the received images of at least one of the plurality of fan blades.

An optical inspection system for a turbine engine according to another exemplary embodiment of this disclosure includes, among other possible things, a probe body extending that is configured to extend into an inlet air flow path, a lens that is disposed on a trailing edge of the probe body with a field of view directed between at least two inlet guide vanes of a plurality of fan blades, a camera that is located remote from the lens and configured to generate images of at least one of the plurality of fan blades, an optic fiber that provides an optical path between the lens and the camera, and a controller that is programmed to determine a condition of at least one of the plurality of fan blades based on images of at least one of the plurality of fan blades.

In a further embodiment of the foregoing, the optical inspection system further includes a lighting device that is disposed within the probe body and configured to illuminate the field of view.

In a further embodiment of any of the foregoing optical inspection systems, the probe body includes a purge flow path for directing a purge flow across the lens.

In a further embodiment of any of the foregoing, the optical inspection system includes a plurality of lenses directed at different fields of view along the plurality of fan blades.

In a further embodiment of any of the foregoing, the optical inspection system further includes a temperature probe that is configured to obtain information indictive of temperature within the inlet air flow path.

In a further embodiment of any of the foregoing optical inspection systems, the controller is further programmed to receive images of a portion of at least one of the plurality of fan blades in response to a rotational speed of the fan being with a predefined speed.

A method of inspecting fan blades of turbine engine according to another exemplary embodiment of this disclosure includes, among other possible things, directing a lens that is disposed within a probe body that extends into an inlet airflow path toward a portion of a fan blade, obtaining images of the portion of the fan blade in response to a rotational speed of a fan being within a predefined range, and determining a condition of the fan blade based on the obtained images.

In a further embodiment of the foregoing, the method further includes directing the lens to provide a field of view between at least two inlet guide vanes upstream of the fan blade.

In a further embodiment of any of the foregoing, the method further includes communicating images of the portion of the fan blade through an optical fiber to a camera located remote from the lens.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a schematic view of an example optical inspection system embodiment.

FIG. 3 is a perspective view of an example probe body embodiment.

FIG. 4 is a schematic view of an example field of view of the example optical inspection system.

FIG. 5 is a schematic view of another example optical inspection system embodiment.

FIG. 6 is a trailing edge view of an other example probe body embodiment.

### DETAILED DESCRIPTION

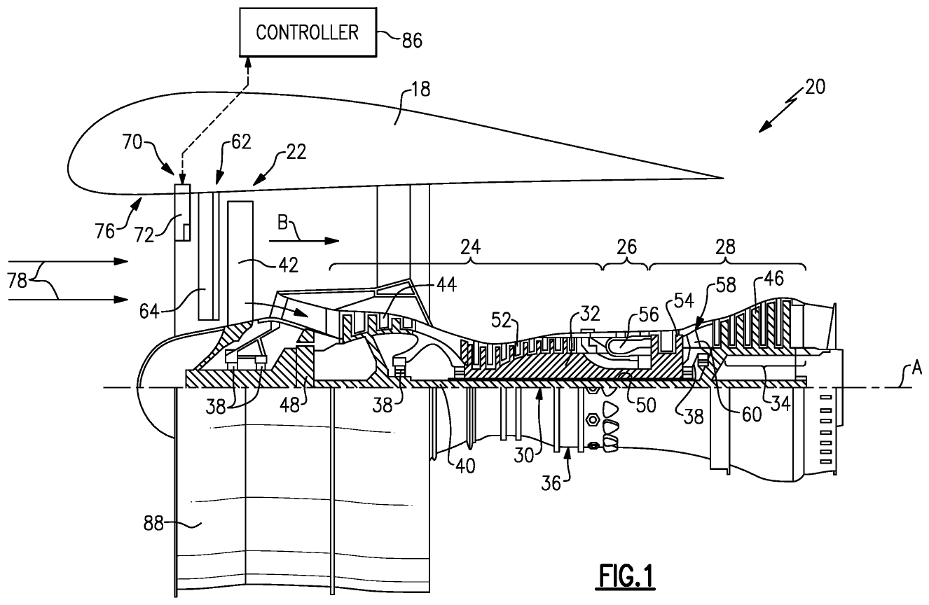

FIG. 1 schematically illustrates a gas turbine engine 20. The example gas turbine engine 20 includes an optical inspection system 70 that generates images of fan blades 42 that are utilized to assess the condition of fan blades 42. The example inspection system 70 includes an optical device with a field of view directed between inlet guide vanes of at least a portion of a fan blade 42.

The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 18, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects the fan section 22, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan section 22 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 58 of the engine static structure 36 is arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan section diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle.

The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

The example gas turbine engine includes the fan section 22 that comprises in one non-limiting embodiment less than about twenty-six (26) fan blades 42. In another non-limiting embodiment, the fan section 22 includes less than about twenty (20) fan blades 42. Moreover, in one disclosed embodiment the low pressure turbine 46 includes no more than about six (6) turbine rotors schematically indicated at 34. In another non-limiting example embodiment, the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

An inlet guide vane assembly 62 includes a plurality of inlet guide vanes 64 disposed forward of the fan blades 42 in the fan section 22. The inlet guide vanes 64 (only one shown) direct incoming inlet air flow 78 toward the fan blades 42 in a preferred direction. Each of the example inlet guide vanes 64 are fixed relative to the rotating fan blades 42 and extend inwardly from a fan case 88. The example fan case 88 circumscribes both the rotating fan blades 42 and the inlet guide vane assembly 62.

Fan blades 42 are exposed to inlet airflow 78 and any debris or objects that may be contained therein. Moreover, portions of each of the fan blades 42 are subject to surface erosion that reduce blade effectiveness.

An optical inspection system 70 is disposed forward of the guide vane assembly 62 and generates images of the fan blades 42 during specific engine operating periods. The images of the fan blades 42 are communicated to a controller 86 and utilized to assess and confirm structural integrity of each of the fan blades 42.

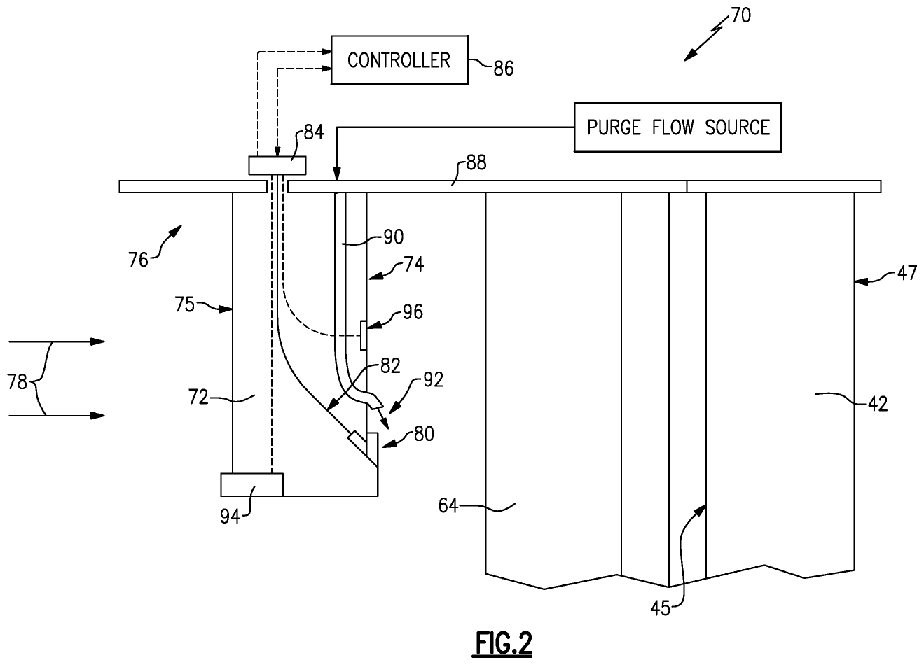

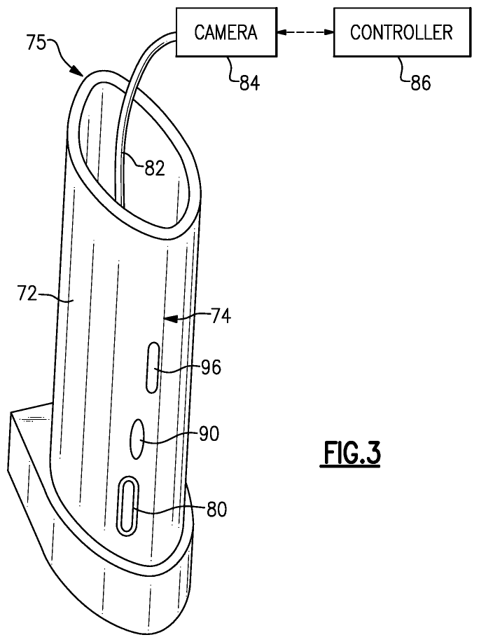

Referring to FIGS. 2 and 3 with continued reference to FIG. 1, the example optical inspection system 70 includes a lens 80 disposed in a probe body 72. The probe body 72 extends into the inlet air flow path 76 from the fan case 88 forward of the inlet guide vane assembly 62. The example probe body 72 includes a leading edge 75 and a trailing edge 74. A lens 80 is provided within the probe body 72 at or near the trailing edge 74 and directed toward the fan blades 42. Images may include the leading edge 45 and trailing edge 47 of each fan blade 42 along with portions of each side. Images are communicated from the lens 80 through an optical path to a camera 84. The camera 84 is located remote from the lens 80. In one disclosed example, the camera 84 is located outside of the probe body 72 and the fan case 88. The example optical path may be an optic fiber 82 or any other lens array or structure that communicates images to the camera 84. The camera 84 is mounted outside of the inlet air flow path 76. Mounting of the camera 84 outside of the inlet airflow path 76 provides a stable environment with smaller temperature and pressure fluctuations. Additionally, the camera 84 is not subject to damage from debris or foreign objects that may be present in the inlet airflow.

The camera 84 generates images that are communicated to a controller 86. The example controller 86 is programmed to use the images to assess a condition of the fan blades 42. In one example embodiment, the controller 86 is further programmed to assess a condition of the fan blades 42 based on images from the camera 84 when the fan section 22 is rotating at lower speeds. In one example embodiment, the low speeds comprise a rotational speed above zero and less than about 500. Although a rotational speed range is disclosed by example, other engine speeds tailored to a specific engine configuration are also within the contemplation and scope of this disclosure.

The example controller 86 includes a system, algorithm and software configured to determine the condition of the fan blades 42 based on predefined acceptance criteria. The example controller 86 is a device and system for performing necessary computing operations of the inspection system 70. The controller 86 may be specially constructed for operation of the inspection system 70, or it may comprise at least a general-purpose computer selectively activated or reconfigured by software instructions stored in a memory device. The controller 86 may further be part of full authority digital engine control (FADEC) or an electronic engine controller (EEC). In one example embodiment, the controller 86 stores image data relating to at least one of the fan blades 42 for review by aircraft mounted or off aircraft systems. The controller 86 may be configured to make determinations with regard to the structural integrity of each of the fan blades 42 and to communicate any determinations to an aircraft operator and/or maintenance technicians. The controller 86 may further be configured to store image data for processing and determination by an aircraft maintenance system separate from the aircraft.

The example probe body 72 may also be utilized to support other measurement and sensing devices. In one example embodiment, the probe body 72 includes a temperature sensor 94 that communicates information indictive of a temperature of the inlet airflow 78 to the controller 86. Although a temperature sensor 94 is disclosed by way of example, other sensing devices may also be utilized and supported within the probe body 72 and are within the contemplation and scope of this disclosure.

The disclosed example probe body 72 further includes a lighting device 96 to illuminate the fan blades 42 as necessary to obtain the desired images for analysis. The example lighting device 96 is illustrated as being disposed within the probe body 72. The lighting device 96 could be provided in other locations that would provide sufficient illumination to capture images of the blades 42.

The probe body 72 may further includes a purge flow path 90 for a purge flow 92. The pure flow 92 is used to clear debris from the lens 80. The purge flow path 90 ends in an opening that directs the purge flow past, across or onto the lens 80 to clear away debris, moisture, or any other obstructions. In one example embodiment, the purge flow is an airflow communicated from a pressurized source of air in the engine. The exhausted purge flow mixes with the inlet airflow 78 and is ingested into the engine. Although a pressurized airflow is disclosed by way of example, other flows may be utilized and are within the contemplation of this disclosure.

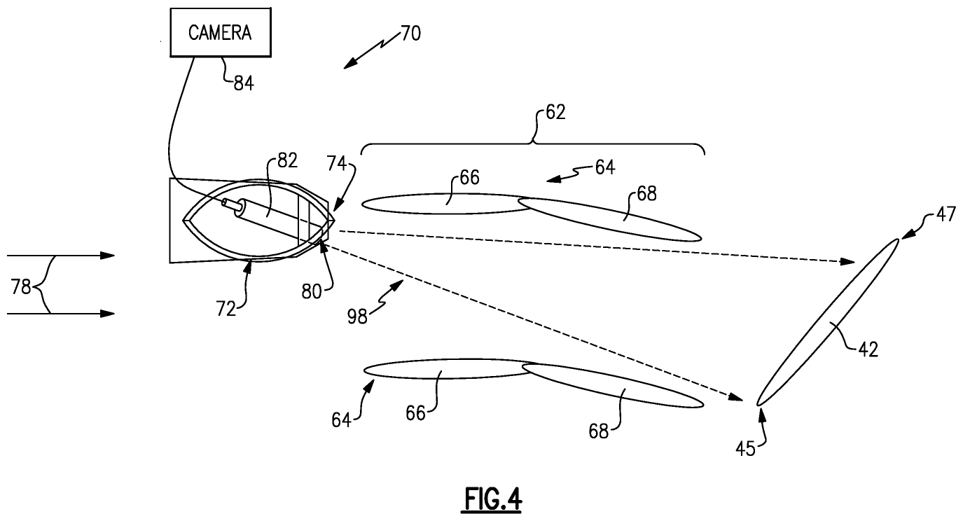

Referring to FIG. 4, with continued reference to FIGS. 2 and 3, the lens 80 is arranged and mounted within the probe body 72 so as to be directed toward the fan blades 42. The lens 80 defines a field of view 98 of the fan blade 42 and between at least two of the inlet guide vanes 64. The example inlet guide vanes 64 includes an upstream static portion 66 and a downstream variable portion 68. The variable portion 68 is movable to adjust a direction of inlet airflow 78 into the fan blades 42. The example inspection system 70 provides for the use of the probe body 72 forward of the inlet guide vane assembly 62 by using the lens 80 with the field of view 98 that is capable of viewing the blade 42 between the two inlet guide vanes 64.

In one disclosed example, the field of view 98 is directed between the inlet guide vanes 64 such that no portion of the inlet guide vanes 64 are captured in any images. In another example embodiment, the field of view 98 is such that desired portions of the fan blade 42 are captured as an image while rotating within a desired rotational speed range. In one disclosed embodiment, the field of view 98 includes some portion of the leading edge 45, trailing edge 47, or both the leading edge 45 and the trailing edge 47.

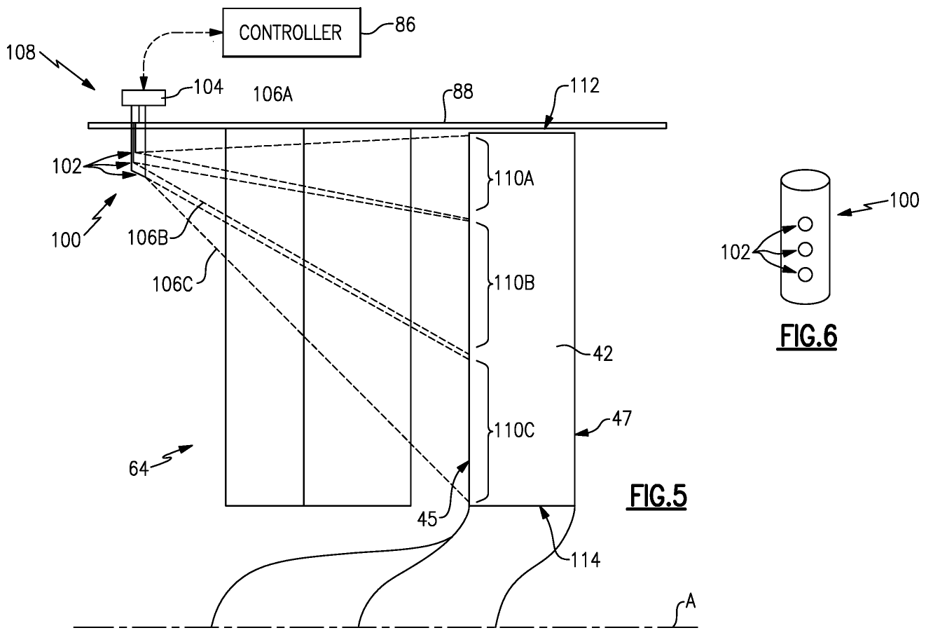

Referring to FIGS. 5 and 6, another example optical inspection system 108 is shown that includes a plurality of lens 102 that each are directed at a different radial location of the fan blade 42. The lenses 102 are all supported in a probe body 100 and communicate to a camera 104. Although a single camera 104 is illustrated by way of example, several cameras 104 may be utilized for a corresponding lens 102. Moreover, an optical fiber (not shown) may be included for each lens 102.

Each of the lenses 102 include a different field of view 106A-C. Each field of view is directed at a specific radial region 110A-C of the fan blade 42 between a tip 112 and a root 114 of the blade 42. Each field of view 106A-C are directed between inlet guide vanes 64 as is shown in FIG. 4. Three radial regions 110A-C are illustrated by way of example, however, more or fewer regions may be utilized and are within the scope and contemplation of this disclosure. The different radial regions 110A-C may enable generation of more focused images for regions on the blade 42.

Accordingly, the disclosed optical inspection system 70 generates images of fan blades 42 that are utilized to assess the condition of fan blades 42 during engine operation and without manual inspection. Moreover, the example inspection system 70 uses a field of view directed between inlet guide vanes 64 to enable implementation without additional structures extending into the inlet flow path.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A turbine engine comprising:
a fan including a plurality of fan blades rotatable about an axis;
an inlet guide vane assembly including a plurality of inlet guide vanes disposed forward of the fan;
a case structure circumscribing the plurality of fan blades and the inlet guide vane assembly, the case structure defining a portion of an inlet air flow path; and
an optical inspection system including a probe body extending from the case structure into the inlet air flow path upstream of the inlet guide vane assembly, the optical inspection system including an optical device at least partially disposed within the probe body with a field of view directed between at least two of the inlet guide vanes of the plurality of fan blades.

2. The turbine engine as recited in claim 1, wherein the optical device comprises a lens disposed within a trailing edge of the probe body and an optical path from the lens to a camera.

3. The turbine engine as recited in claim 2, wherein the camera is disposed at a location remote from the lens.

4. The turbine engine as recited in claim 3, wherein the optical path comprises an optical fiber between the lens and the camera.

5. The turbine engine as recited in claim 3, further including a lighting device disposed within the probe body and configured to illuminate the field of view.

6. The turbine engine as recited in claim 4, further comprising a purge flow path for directing a purge flow across the lens.

7. The turbine engine as recited in claim 1, wherein the inlet guide vanes are at least partially variable to adjust a direction of inlet airflow toward the plurality of fan blades.

8. The turbine engine as recited in claim 1, wherein the optical inspection system includes at least two optical devices that are focused on a different radial region of the plurality of fan blades.

9. The turbine engine as recited in claim 1, further comprising a temperature probe disposed in the probe body.

10. The turbine engine as recited in claim 1, wherein the optical inspection system further comprises a controller programmed to receive images of a portion of at least one of the plurality of fan blades in response to a rotational speed of the fan being with a predefined speed.

11. The turbine engine as recited in claim 10, wherein the controller is further programmed to determine a condition of at least one of the plurality of fan blades based on the received images of at least one of the plurality of fan blades.

12. An optical inspection system for a turbine engine comprising:
a probe body extending configured to extend into an inlet air flow path;
a lens disposed on a trailing edge of the probe body with a field of view directed between at least two inlet guide vanes of a plurality of fan blades;
a camera located remote from the lens and configured to generate images of at least one of the plurality of fan blades;
an optic fiber providing an optical path between the lens and the camera; and
a controller programmed to determine a condition of at least one of the plurality of fan blades based on images of at least one of the plurality of fan blades.

13. The optical inspection system as recited in claim 12, further including a lighting device disposed within the probe body and configured to illuminate the field of view.

14. The optical inspection system as recited in claim 13, wherein the probe body includes a purge flow path for directing a purge flow across the lens.

15. The optical inspection system as recited in claim 12, including a plurality of lenses directed at different fields of view along the plurality of fan blades.

16. The optical inspection system as recited in claim 12, further including a temperature probe configured to obtain information indictive of temperature within the inlet air flow path.

17. The optical inspection system as recited in claim 12, wherein the controller is further programmed to receive images of a portion of at least one of the plurality of fan blades in response to a rotational speed of the fan being with a predefined speed.

18. A method of inspecting fan blades of turbine engine comprising:
directing a lens disposed within a probe body that extends into an inlet airflow path toward a portion of a fan blade;
obtaining images of the portion of the fan blade in response to a rotational speed of a fan being within a predefined range; and
determining a condition of the fan blade based on the obtained images.

19. The method as recited in claim 18, further comprising directing the lens to provide a field of view between at least two inlet guide vanes upstream of the fan blade.

20. The method as recited in claim 18, further comprising communicating images of the portion of the fan blade through an optical fiber to a camera located remote from the lens.
